(19) United States
(12) Patent Application Publication
(10) Pub. No.: US 2008/0015280 A1
(43) Pub. Date: Jan. 17, 2008

(54) Photosensitive Composition for Forming Optical Waveguide and Optical Waveguide

(75) Inventors: Hideaki Takase, Tokyo (JP); Yuuichi Eriyama, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR Corporation, Chuo-ku, Tokyo (JP)

(21) Appl. No.: 10/592,059

(22) PCT Filed: Feb. 23, 2005
(86) PCT No.: PCT/JP05/03433

§ 371 Date: Mar. 26, 2007

(30) Foreign Application Priority Data
Mar. 11, 2004 (JP) 2004-068734

(51) Int. Cl. C08F 2/46

(52) U.S. Cl. 522/183

(57) ABSTRACT

A radiation-sensitive composition for forming optical waveguides, which can stably exhibit low transmission loss, high heat resistance, and high adhesion to a substrate such as a silicon wafer and the like, over a long period of time even under severe conditions is provided. The composition comprises: from 5 to 50 mass percent of a (meth)acrylate having an adamantyl group represented by general formula (1) or (2);

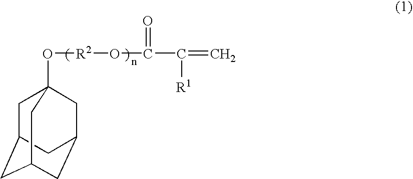

(in the formula, R¹ is a hydrogen atom or a methyl group; R² is —CH₂CH₂—, —CH₂CH(CH₃)—, or —CH₂CH(OH)CH₂—; n is an integer from 0 to 10)

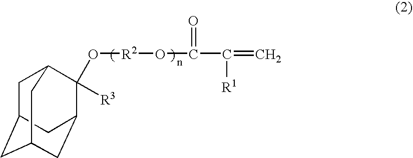

(in the formula, R¹ is a hydrogen atom or a methyl group; R² is —CH₂CH₂—, —CH₂CH(CH₃)—, or —CH₂CH(OH)CH₂—; R³ is a hydrogen atom, a methyl group, or an ethyl group; n is an integer from 0 to 10); from 40 to 94.99 mass percent of other photopolymerizable compounds; and from 0.01 to 10 mass percent of a photopolymerization initiator. The composition is used as the material of both or any one of the clad layers 3,4 and the core portion 5 of the optical waveguide 1.

### TECHNICAL FIELD

The present invention relates to a radiation-sensitive composition for forming optical waveguides, for manufacturing optical circuits used in optical communication fields or optical information processing fields, and also relates to an optical waveguide manufactured by using the radiation-sensitive composition.

### BACKGROUND ART

As we enter the multimedia age, due to demands to increase the capacity and speed of data processing in optical communication systems and computers, transmission systems including optical transmission mediums have come to be used in public telecommunication networks, LANs (i.e. local area networks), FAs (i.e. factory automations), interconnects between computers, household wirings, and the like.

Among components constituting the transmission system, an optical waveguide is a basic constituent of optical devices for realizing optical computers or high-capacity communications such as movies, moving images, and the like; optoelectronic integrated circuits (OEIC); optical integrated circuits (Optical IC); or the like. Since there is a very large market for the optical waveguide, diligent study on the optical waveguide has been conducted, and especially, a product with higher performance and lower cost is needed.

As material for the optical waveguide, multicomponent glasses such as quartz glass, soda-lime glass and the like, as well as various organic polymers are known.

For example, there has been proposed an optical waveguide in which a core portion is formed by quartz and at least one of a lower clad layer and an upper clad layer is formed by organic polymer such as poly(methyl methacrylate), polystyrene, polyimide, poly(trifluoroisopropyl methacrylate), and the like (see Japanese Laid-Open Patent Publication H10-300955).

### DISCLOSURE OF THE INVENTION

A radiation-sensitive resin composition composed of a mixture of (meth) acrylate monomers, which has been used as material for optical waveguides conventionally, can be cured by being irradiated with ultraviolet light for a few minutes, so that it is possible to improve manufacturing efficiency and reduce cost.

However, publicly known (meth)acrylate resin compositions sometimes cause troubles such as high transmission loss, insufficient heat resistance, increase in transmission loss due to moisture absorption, separation from a substrate due to curing shrinkage, and the like.

A radiation-sensitive resin composition comprising a fluorinated (meth)acrylate monomer, such as poly(trifluoroisopropyl methacrylate) and the like, has an advantage in transmission loss, but has a disadvantage that a waveguide separates from the substrate due to decreased adhesion to a substrate.

It is thus an object of the present invention to provide a radiation-sensitive composition for forming optical waveguides, which can stably exhibit low transmission loss, high heat resistance, and high adhesion to a substrate such as a silicon wafer and the like, over a long period of time even under severe conditions.

As a result of diligent study aimed at solving the above problems, the inventors perfected the present invention upon discovering that an optical waveguide that has excellent characteristics mentioned above can be manufactured by using a radiation-sensitive composition comprising specific (meth)acrylate and photopolymerization initiator.

More specifically, the radiation-sensitive composition for forming optical waveguides of the present invention is characterized in that the composition comprises a (meth)acrylate having an adamantyl group and a photopolymerization initiator.

In a preferred embodiment, the composition comprises: from 5 to 50 mass percent of a (meth) acrylate having an adamantyl group represented by general formula (1) or (2)

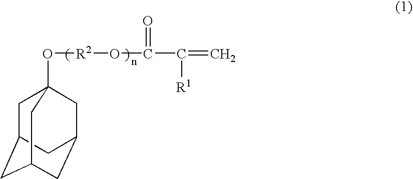

(in the formula, R¹ is a hydrogen atom or a methyl group; R² is —CH₂CH₂—, —CH₂CH(CH₃)—, or —CH₂CH(OH)CH₂—; n is an integer from 0 to 10)

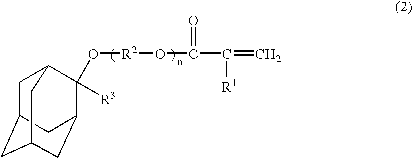

(in the formula, R¹ is a hydrogen atom or a methyl group; R² is —CH₂CH₂—, —CH₂CH(CH₃)—, or —CH₂CH(OH)CH₂—; R³ is a hydrogen atom, a methyl group, or an ethyl group; n is an integer from 0 to 10); from 40 to 94.99 mass percent of another photopolymerizable compound; and from 0.01 to 10 mass percent of a photopolymerization initiator.

A cured product of the radiation-sensitive composition for forming optical waveguides of the present invention preferably has a glass-transition temperature (Tg) of at least 80 degree C.

An optical waveguide of the present invention comprises a lower clad layer, a core portion formed on a part of the lower clad layer, and an upper clad layer formed on the lower clad layer for covering the core portion, wherein at least one selected form the lower clad layer, the core portion, and the upper clad layer is a cured product of the radiation-sensitive composition mentioned above.

By using the radiation-sensitive composition of the present invention, it is possible to manufacture an optical waveguide which can stably keep low transmission loss, high heat resistance, high adhesion to a substrate such as a silicon wafer and the like, over a long period of time even under severe conditions.

### BRIEF DESCRIPTION OF THE DRAWINGS

FIG. 1 is a sectional view schematically illustrating an example of an optical waveguide including clad layers composed of a radiation-sensitive composition of the present invention.

### BEST MODE FOR CARRYING OUT THE INVENTION

A radiation-sensitive composition for forming waveguides comprises (A) a (meth)acrylate having an adamantyl group, (B) other photopolymerizable compounds added optionally, and (C) a photopolymerization initiator. Each of the components will now be described in detail.

### [(A) (Meth)acrylate having an adamantyl group]

(A) A (meth)acrylate having an adamantyl group used in the present invention has no limitations on the type thereof, and has only to be a (meth)acrylate having an adamantyl group in the molecule thereof.

Examples of the (meth)acrylate having an adamantyl group include a compound represented by the general formula (1)

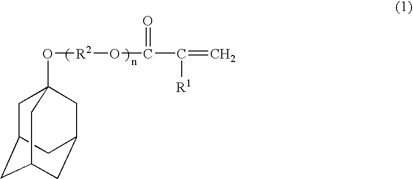

(in the formula, R¹ is a hydrogen atom or a methyl group; R² is —CH₂CH₂—, —CH₂CH(CH₃)—, or —CH₂CH(OH)CH₂—; n is an integer from 0 to 10), and a compound represented by the general formula (2)

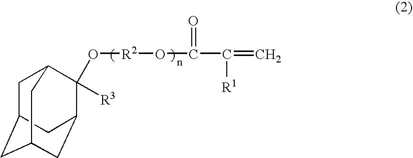

(in the formula, R¹ is a hydrogen atom or a methyl group; R² is —CH₂CH₂—, —CH₂CH(CH₃)—, or —CH₂CH (OH) CH₂—; R³ is a hydrogen atom, a methyl group, or an ethyl group; n is an integer from 0 to 10).

The (meth)acrylate having an adamantyl group represented by the general formula (1) or (2), in which n is 0, is an ester of an alcohol having an adamantyl group and (meth) acrylic acid. Here, examples of the alcohol having an adamantyl group include 1-adamantanol, 2-adamantanol, 2-methyl-2-adamantanol, 2-ethyl-2-adamantanol.

In the general formulae (1) and (2), n is preferably in the range of 0 to 5, more preferably in the range of 0 to 3. When n is in the preferred range, it is possible to keep good transmission loss even after storage in heat and humidity for a long period of time.

By using the (meth)acrylate having an adamantyl group as a constituent component of a radiation-sensitive composition, the radiation-sensitive composition can exhibit improved heat resistance (i.e. increased glass-transition temperature), increased adhesion to a substrate such as a silicon wafer and the like (i.e. decreased curing shrinkage ratio), improved long-term reliability (i.e. long-term retention of low transmission loss under severe conditions such as low temperature, high temperature and high humidity, drastic temperature change, etc.), and the like.

The radiation-sensitive composition of the present invention includes (A) a (meth)acrylate having an adamantyl group in an amount of preferably from 5 to 50 mass percent, more preferably from 10 to 40 mass percent, most preferably from 15 to 30 mass percent. When the amount is less than 5 mass percent, problems such as an increase in the transmission loss, and an occurrence of a large curing shrinkage that is followed by a separation depending on use conditions, can occur after storage in heat and humidity, and other problems can also occur. When the amount exceeds 50 mass percent, it may be difficult to obtain an intended refractive index, and other problems can also occur.

### [(B) Other Photopolymerizable Compounds]

Examples of (B) other photopolymerizable compounds usable in the present invention include a (meth)acrylate other than component (A), a compound having a vinyl group, and the like.

Component (B) has only to have one or more ethylenically unsaturated groups in the molecule thereof, and any of a monomer, a reactive oligomer, or a reactive polymer (i.e. macropolymer) can be used.

Examples of a (meth) acrylate having one (meth) acryloyl group in the molecule thereof include a macromonomer having a number average molecular weight of 3,000 to 10,000, and other (meth)acrylates.

Examples of the macromonomer include a poly(methyl methacrylate) having a methacryloyl group (i.e. methacryloyl group-containing PMMA), a polystyrene having a methacryloyl group, and the like.

Examples of other (meth) acrylates having one (meth) acryloyl group in the molecule thereof include a (meth)acrylate having a phenoxy group such as phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 2-hydroxy-3-phenoxypropyl (meth)acrylate, (meth)acrylate of ethylene oxide modified p-cumylphenol, 2-bromophenoxyethyl (meth)acrylate, 4-bromophenoxyethyl (meth)acrylate, 2,4-dibromophenoxyethyl (meth)acrylate, 2,6-dibromophenoxyethyl (meth)acrylate, 2,4,6-tribromophenoxyethyl (meth)acrylate, and the like; isobornyl (meth)acrylate, bornyl (meth)acrylate, tricyclodecanyl (meth) acrylate, dicyclopentanyl (meth) acrylate, dicyclopentenyl (meth)acrylate, cyclohexyl (meth)acrylate, benzyl (meth)acrylate, 4-butylcyclohexyl (meth)acrylate, acryloylmorpholine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, polyethylene glycol mono(meth)acrylate, polypropylene glycol mono(meth)acrylate, methoxyethylene glycol (meth) acrylate, ethoxyethyl (meth) acrylate, methoxypolyethylene glycol (meth)acrylate, methoxypolypropylene glycol (meth)acrylate, diacetone (meth)acrylamide, isobutoxymethyl (meth)acrylamide, N,N-dimethyl (meth)acrylamide, t-octyl (meth)acrylamide, dimethylaminoethyl (meth)acrylate, diethylaminoethyl (meth)acrylate, 7-amino-3,7-dimethyloctyl (meth)acrylate, and the like.

Examples of a (meth)acrylate having two (meth)acryloyl groups in the molecule thereof include a bisphenol-containing di(meth)acrylate, an alkyl diol diacrylate, and other (meth)acrylates.

Examples of a bisphenol-containing di (meth) acrylate include di(meth)acrylate of ethylene oxide adduct of bisphenol A, di (meth) acrylate of ethylene oxide adduct of tetrabromobisphenol A, di(meth)acrylate of propylene oxide adduct of bisphenol A, di (meth) acrylate of propylene oxide adduct of tetrabromobisphenol A, bisphenol A epoxy di(meth)acrylate which is obtained by epoxy ring-opening reaction of bisphenol A diglycidyl ether with (meth) acrylic acid, tetrabromobisphenol A epoxy di (meth) acrylate which is obtained by epoxy ring-opening reaction of tetrabromobisphenol A diglycidyl ether with (meth) acrylic acid, bisphenol F epoxy di(meth)acrylate which is obtained by epoxy ring-opening reaction of bisphenol F diglycidyl ether with (meth) acrylic acid, tetrabromobisphenol F epoxy di (meth) acrylate which is obtained by epoxy ring-opening reaction of tetrabromobisphenol F diglycidyl ether with (meth) acrylic acid, and the like.

Examples of an alkyl diol diacrylate include 1,4-butanediol diacrylate, 1,6-hexanediol diacrylate, 1,9-nonanediol diacrylate, and the like.

Examples of other (meth) acrylates having two (meth) acryloyl groups in the molecule thereof include a polyalkylene glycol diacrylate such as ethylene glycol di(meth)acrylate, tetraethylene glycol diacrylate, tripropylene glycol diacrylate, and the like; neopentyl glycol di(meth)acrylate, tricyclodecane dimethanol diacrylate, and the like.

Examples of a (meth)acrylate having three (meth)acryloyl groups in the molecule thereof include trimethylolpropane tri(meth)acrylate, pentaerythritol tri(meth)acrylate, trimethylolpropanetrioxyethyl (meth)acrylate, tris(2-acryloyloxyethyl)isocyanurate, pentaerythritol polyacrylate, and the like.

Examples of a compound having a vinyl group include N-vinylpyrrolidone, N-vinylcaprolactam, vinylimidazole, vinylpyridine, and the like.

From a viewpoint of improving heat resistance of a cured product or the like, it is preferable that the whole or a part of component (B) is composed of a (meth)acrylate having two or more (meth)acryloyl groups in the molecule thereof.

As component (B), one compound may be used alone, or two or more compounds may be used in combination. The type and the amount to be added of component (B) may be determined as appropriate considering the intended refractive index and the like of the cured radiation-sensitive composition.

The radiation-sensitive composition of the present invention includes (B) other photopolymerizable compounds in an amount of preferably from 40 to 94.99 mass percent, more preferably from 53 to 89.9 mass percent, most preferably from 65 to 84.5 mass percent. When the amount is less than 40 mass percent, it may be difficult to obtain the intended refractive index, and other problems can also occur. When the amount exceeds 94.99 mass percent, it becomes difficult to satisfy all the characteristics required for the optical waveguide, such as long-term reliability, heat resistance (i.e. glass-transition temperature; Tg), adhesion of the waveguide to the substrate, and the like.

### [(C) Photopolymerization Initiator]

As a photopolymerization initiator used in the present invention, it is preferable to use a compound capable of generating activated radical species by being irradiated with activated energy ray such as ultraviolet light (i.e. a photo-radical polymerization initiator).

Examples of the photopolymerization initiator include acetophenone, acetophenone benzyl ketal, 1-hydroxycyclohexyl phenyl ketone, 2-benzyl-2-dimethylamino-1-(4-morpholinophenyl)-butanone-1, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2,4,6-trimethylbenzoyldiphenylphosphine oxide, bis-(2,6-dimethoxybenzoyl)-2,4,4-trimethylpentylphosphine oxide, and the like.

When any polymerization initiator other than the photopolymerization initiator is used, and polymerization is performed not by irradiation but by heat, etc., it requires long-term heating to cure thoroughly. Accordingly, polymerization by heat is not preferred from a view point of productivity. In addition, if a silicon wafer is used as the substrate, the optical waveguide is likely to separate from the substrate when placed back to room temperature after cured by heat due to a difference in heat shrinkage ratio between the optical waveguide and the substrate.

In the present invention, the radiation-sensitive composition includes (C) a photopolymerization initiator in an amount of preferably from 0.01 to 10 mass percent, more preferably from 0.1 to 7 mass percent, most preferably from 0.5 to 5 mass percent. When the amount is less than 0.01 mass percent, problems such as a decrease in patterning properties, a decrease in curing speed, and the like, can occur. When the amount exceeds 10 mass percent, problems such as a decrease in patterning properties, a deterioration in transmission characteristics, and the like, can occur.

The radiation-sensitive composition of the present invention can further contain a solvent, photosensitizer, antioxidant, UV absorber, light stabilizer, silane coupling agent, coating surface improver, thermal polymerization inhibitor, leveling agent, surfactant, colorant, storage stabilizer, plasticizer, lubricant, filler, aging resistor, wetting agent, mold release agent, and the like as appropriate.

The radiation-sensitive composition of the present invention can be manufactured by mixing the above components in the usual manner.

The radiation-sensitive composition of the present invention has a viscosity of generally from 100 to 20,000 cp at 25 degree C., preferably from 200 to 10,000 cp at 25 degree C, more preferably from 300 to 5,000 cp at 25 degree C. When the viscosity is too high, an unevenness or swell sometimes occurs when the radiation-sensitive composition is applied onto the substrate. When the viscosity is too low, it is sometimes difficult to obtain an intended film thickness. The viscosity can be adjusted by determining the type and the amount to be added of the monomers or the solvent as appropriate.

The cured product of the radiation-sensitive composition of the present invention, which is obtained by irradiating the radiation-sensitive composition with radiation such as ultraviolet light to cure, preferably has the following characteristics.

When the radiation-sensitive composition of the present invention is used as material for a core portion of an optical waveguide, the cured product of the radiation-sensitive composition has a refractive index n_{D}²⁵ preferably of 1.54 or more, more preferably of 1.55 or more. When the refractive index is less than 1.54, good transmission characteristics (i.e. low waveguide loss) sometimes cannot be obtained.

When the radiation-sensitive composition of the present invention is used as material for a clad layer of an optical waveguide, the cured product of the radiation-sensitive composition has a refractive index n_{D}²⁵ preferably at least 0.01 lower than the refractive index n_{D}²⁵ of the core portion, more preferably at least 0.03 lower than the refractive index n_{D}²⁵ of the core portion. When the difference in the refractive indexes is not less than 0.01, it is possible to obtain lower waveguide loss.

Here, the term “refractive index n_{D}²⁵” means the refractive index when an emission ray of Na at 589 nm is passed through at 25 degree C.

The cured product of the radiation-sensitive composition of the present invention has a glass-transition temperature (Tg) preferably of 80 degree C. or higher, more preferably of 100 degree C. or higher, most preferably of 110 degree C. or higher. When the glass-transition temperature is less than 80 degree C., the optical waveguide sometimes has insufficient heat resistance.

Here, the term “glass-transition temperature” means the temperature where a loss tangent shows a maximum value, which is measured using a sympathetic vibration dynamic viscoelasticity measuring apparatus with a vibrational frequency of 10 Hz.

The cured product of the radiation-sensitive composition of the present invention has a curing shrinkage ratio preferably of 10% or less, more preferably of 8% or less. When the curing shrinkage ratio exceeds 10%, adhesion to the substrate such as a silicon wafer and the like decreases, resulting in that the separation from the substrate depending on use conditions is likely to cause.

The radiation-sensitive composition of the present invention can be used as the materials of both or any one of the core portion and the clad layers, wherein the core portion and the clad layers constitute the optical waveguide. The radiation-sensitive composition of the present invention can be preferably used as at least the material for the lower clad layer due to excellent adhesion to the substrate.

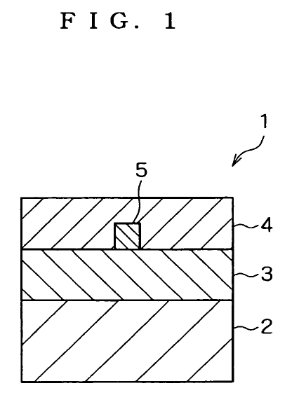

FIG. 1 is a sectional view schematically illustrating an example of an optical waveguide including the clad layers composed of a radiation-sensitive composition of the present invention.

In FIG. 1, an optical waveguide 1 comprises substrate 2 such as a silicon wafer, a lower clad layer 3, an upper clad layer 4, and a core portion 5 protected by the clad layers 3 and 4. Of these, the lower clad layer 3 and the upper clad layer 4 are formed using the radiation-sensitive composition of the present invention.

An example of a method for manufacturing the optical waveguide 1 is as follows.

First, the radiation-sensitive composition of the present invention is applied onto the substrate 2 using a spin coater, and then irradiated with ultraviolet light to be cured, thus forming the lower clad layer 3. Next, another radiation-sensitive composition for forming the core portion is applied onto the lower clad layer 3, and irradiated with ultraviolet light from the upper side, via a photo-mask having a prescribed line pattern. By this irradiation, only the irradiated parts are cured, and the other parts, that is the uncured parts, are then removed using a developer. In this way, the core portion 5 can be obtained.

Next, the radiation-sensitive composition of the present invention is applied onto the upper surfaces of the lower clad layer 3 and the core portion 5, and then irradiated with ultraviolet light to be cured and form the upper clad layer 4, thus accomplishing the optical waveguide 1.

### EXAMPLES

The present invention will now be described based on the following Examples.

### [1. Preparation of Radiation-Sensitive Composition]

Components listed in Table 1 were put into a flask, and stirred to become a transparent liquid while maintaining the liquid temperature at 60 degree C., thus obtaining a liquid radiation-sensitive composition (“Composition 1” to “Composition 5” in Table 1).

### [2. Evaluation of Radiation-Sensitive Composition]

Characteristics of the obtained radiation-sensitive compositions were evaluated as follows.

(a) Refractive Index

The refractive index was measured using an Abbe refractive index detector, wherein an emission line of Na at 589 nm was passed through.

(b) Glass-Transition Temperature

The radiation-sensitive composition was applied onto a glass substrate to be 120 μm thick using an applicator to form a composition layer, and then, the composition layer was irradiated with ultraviolet light at 1.0 J/cm² in a nitrogen atmosphere using a conveyor UV irradiation device, thus obtaining a cured film. Next, a temperature dependence of a loss tangent was measured for the cured film at a vibrational frequency of 10 Hz using a sympathetic vibration dynamic viscoelasticity measuring apparatus. The temperature where the obtained loss tangent reached a maximum was taken as the glass-transition temperature.

(c) Curing Shrinkage Ratio

The liquid density (D1) of the radiation-sensitive composition was measured at 23 degree C. using a pycnometer. Next, a cured film having a thickness of 120 μm was manufactured by the same method as the above “(b) Glass-transition temperature”, and the film was left for 24 hours in a thermo-hygrostat of 23 degree C and 50% humidity. A sample of 40 millimeter cube was then obtained by being cut out, and weighed (W1). The sample also weighed in distilled water at 25 degree C. (W2). The film density (D2) was calculated using the following expression.

Film density=[W1/(W1-W2)]×0.9971

By using the values of D1 and D2, the curing shrinkage ratio was calculated using the following expression.

Curing shrinkage ratio=[1−(D1/D2)]×100

(d) Separation Resistance

The radiation-sensitive composition was applied onto a surface-treated quartz substrate using an applicator, to be a coating film having a thickness of 50 μm. Next, the coating film of the radiation-sensitive composition was irradiated with ultraviolet light at a radiation dose of 500 mJ/cm² using a conveyor UV irradiation device equipped with a metal halide lamp having a maximum light intensity of 250 mW/cm², to be cured. The adhesion was evaluated by a cross-cut peeling test using sellotape in accordance with JIS K5600-5-6. When 100 squares in the grid were observed, the case that 80 or more squares remained without peeled off were taken as “o”, the case that not less than 50 but less than 80 squares were remained without peeled off was taken as “▴”, and the case that less than 50 squares remained were taken as “x”.

TABLE 1

| | | Composition 1 | Composition 2 | Composition 3 | Composition 4 | Composition 5 |
|---|---|---|---|---|---|---|
| Component (A): | | | | | | |
| ADA | R¹=hydrogen atom | 18.5 | — | — | — | — |
| ADMA | R¹=methyl group | — | 18.5 | 19.4 | — | — |
| Component (B): | | | | | | |
| AA-6 | reactive polymer | 27.8 | 27.8 | — | 27.8 | — |
| V779 | monomer | — | — | 29.1 | — | 29.1 |
| ACMO | monomer | 13.9 | 13.9 | 9.7 | 13.9 | 9.7 |
| NDDA | monomer | 27.8 | 27.8 | — | 27.8 | — |
| TCDDA | monomer | 9.3 | 9.3 | 29.1 | 9.3 | 48.5 |
| IBXMA | monomer | — | — | — | 18.5 | — |
| BR-31 | monomer | — | — | 9.7 | — | 9.7 |
| Component (C): | | | | | | |
| Irg.184 | photopolymerization | 2.8 | 2.8 | 3.0 | 2.8 | 3.0 |
| | initiator | | | | | |

| | | | | | |
|---|---|---|---|---|---|
| Refractive index(n_{D}²⁵ ) | 1.51 | 1.51 | 1.55 | 1.50 | 1.56 |
| Glass-transition temperature (° C.) | 145 | 150 | 150 | 140 | 160 |
| Curing shrinkage ratio (%) | 6.8 | 6.7 | 6.7 | 7.2 | 7.1 |
| Separation resistance | ∘ | ∘ | ∘ | x | x |

unit: mass %
ADA: acrylate having an adamantyl group (ADA manufactured by OSAKA ORGANIC CHEMICAL INDUSTRY LTD.)
ADMA: methacrylate having an adamantyl group (ADMA manufactured by OSAKA ORGANIC CHEMICAL INDUSTRY LTD.)
AA-6: PMMA having a methacryloyl group (Macromer AA-6 manufactured by TOAGOSEI CO., LTD.; number average molecular weight: 6,000)
V799: epoxy dimethacrylate of tetrabromobisphenol A (V779 manufactured by Japan U-PiCA Company, Ltd.)
ACMO: acryloylmorpholine (ACMO manufactured by KOHJIN Co., Ltd.)
NDDA: 1,9-nonanediol diacrylate (LC9A manufactured by DAI-ICHI KOGYO SEIYAKU CO., LTD.)
TCDDA: tricyclodecane dimethanol diacrylate (SA1002 manufactured by Mitsubishi Chemical Corporation)
IBXMA: isobornyl methacrylate (IB-X manufactured by OSAKA ORGANIC CHEMICAL INDUSTRY LTD.)
BR-31: tetrabromophenoxyethyl acrylate (BR-31 manufactured by DAI-ICHI KOGYO SEIYAKU CO., LTD.)
Irg.184: cyclohexylacetophenone (Irgacure 164 manufactured by Ciba Specialty Chemicals)

### [3. Manufacture of Optical Waveguide]

A radiation-sensitive composition for a clad layer shown in Table 2 was applied onto a substrate composed of a silicon wafer (thickness: 0.5 mm) using a spin coater, and then, irradiated with ultraviolet light having a wavelength of 365 nm and a light intensity of 35 mW/cm² for 30 seconds using a mask aligner to be cured, thus forming a lower clad layer (thickness: 40 μm).

A radiation-sensitive composition for a core portion shown in Table 2 was applied onto the lower clad layer using a spin coater, and then, exposure was carried out by irradiating ultraviolet light having a wavelength of 365 nm and a light intensity of 35 mW/cm² for 10 seconds, via a photo-mask having a 50 μm-width waveguide pattern. The substrate after the exposure was soaked into acetone, so that the unexposed parts were resolved. Heating was then carried out for 10 minutes at 100 degree C., thus forming a core portion (thickness: 50 μm).

Furthermore, the same radiation-sensitive composition as that for the lower clad layer was applied onto the upper surfaces of the lower clad layer and the core portion using a spin coater, and then, irradiated with ultraviolet light having a wavelength of 365 nm and a light intensity of 35 mW/cm² for 30 seconds to be cured, thus forming an upper clad layer (thickness from the upper surface of the core portion: 40 μm).

Thus, an optical waveguide comprising the core portion and the clad layers was completed.

### [4. Evaluation of Optical Waveguide]

The obtained optical waveguides were evaluated as follows. (a) Waveguide loss The waveguide loss was measured using a cutback method, wherein the end face of the optical waveguide was cut by cleavage, and light having a wavelength of 850 nm was then inserted through a multimode fiber (50 μm in diameter). The cutback was carried out such that the measurement was carried out at five points at 1 cm interval from the end of the waveguide having a length of 5 cm. The obtained light intensity was plotted against the waveguide length, and the value of the loss was obtained by the gradient. The case that the obtained value of the loss was 0.5 dB/cm or less was taken as “o”, and the case that the obtained value of the loss was more than 0.5 dB/cm was taken as “x”.

(b) Temperature Characteristics
The following (1) to (3) were evaluated. (1) Change in optical characteristics at low temperature A linear waveguide having a waveguide length of 20 mm was prepared and the initial insertion loss was measured. After that, the linear waveguide was left for 500 hours at −40 degree C. and again the insertion loss was measured. The degree of change in the insertion loss between before and after the low-temperature treatment was calculated. The case that the degree of change in the insertion loss (i.e. the degree of increase from the initial insertion loss) exceeded 1.0 dB was taken as “x”, and the case that the amount of change in the insertion loss was 1.0 dB or less was taken as “o”.

### (2) Change in optical characteristics at high temperature and high humidity.

By the same method as above, the initial insertion loss was measured, and then, the waveguide was left for 1,000 hours at high temperature and high humidity (temperature: 85 degree C., relative humidity: 85%). After that, the insertion loss was measured again. The degree of change in the insertion loss between before and after the high-temperature and high-humidity treatment was calculated. The case that the degree of change in the insertion loss (i.e. the degree of increase from the initial insertion loss) exceeded 1.0 dB was taken as “x”, and the case that the degree of change in the insertion loss was 1.0; dB or less was taken as “o”.

### (3) Change in optical characteristics in heat cycle.

After the initial insertion loss was measured by the same method as that described above, a heat cycle, in which the waveguide was left at a temperature of −40 degree C. for 30 minutes, and then, left at a temperature of 85 degree C. for 30 minutes, was repeated; 500 times. After that, the insertion loss was measured again. The degree of change in the insertion loss between before and after the heat cycle treatment was calculated. The case that the degree of change in the insertion loss (i.e. the degree of increase from the initial insertion loss) exceeded 1.0 dB was taken as “x”, and the case that the degree of change in the insertion loss was 1.0 dB or less was taken as “o”.

| | | | | Comparative | Comparative |
|---|---|---|---|---|---|
| | Example 1 | Example 2 | Example 3 | Example 1 | Example 2 |
| [Optical waveguide] | | | | | |
| Core portion | PJ300l | PJ3001 | Composition 3 | Composition 5 | PJ3001 |
| Clad layer | Composition 1 | Composition 2 | Composition 1 | Composition 4 | Composition 4 |
| [Characteristics] | | | | | |
| Transmission loss | ∘ | ∘ | ∘ | ∘ | ∘ |
| Temperature characteristics | | | | | |
| Low temperature | ∘ | ∘ | ∘ | x | x |
| High temperature and high humidity | ∘ | ∘ | ∘ | ∘ | ∘ |
| Heat cycle | ∘ | ∘ | ∘ | x | x |

PJ3001: radiation-sensitive acrylic resin composition (manufactured by JSR Corporation)

1: A radiation-sensitive composition for forming optical waveguides, which comprises: a (meth)acrylate having an adamantyl group; and a photopolymerization initiator.

2. A radiation-sensitive composition for forming waveguides, which comprises: from 5 to 50 mass percent of a (methacrylate having an adamantyl group represented by general formula (1) or (2); 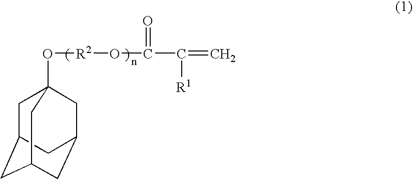
(in the formula, R₂ is a hydrogen atom or a methyl group; R² is —CH₂CH₂—, —CH₂CH(CH₃)—, or —CH₂CH(OH)CH₂—; n is an integer from 0 to 10) 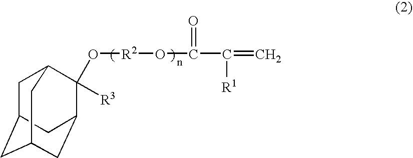
(in the formula, R¹ is a hydrogen atom or a methyl group; R² is —CH₂CH₂—, —CH₂CH(CH₃)—, or from 0 to 10); from 40 to 94.99 mass percent of other photopolymerizable compounds; and from 0.01 to 10 mass percent of a photopolymerization initiator.

3. The radiation-sensitive composition for forming optical waveguides according to claim 17 wherein a cured product of the radiation-sensitive composition has a glass-transition temperature of 80 degree C. or higher.

4. (canceled)

5. The radiation-sensitive composition for forming optical waveguides according to claim 1, wherein a cured product of the radiation-sensitive composition has a glass-transition temperature of 45 degree C. or higher.

6. A radiation-sensitive composition for forming optical waveguides according to claim 1, which further comprises tricyclodecane dimethanol diacrylate.

7. An optical waveguide which comprises a lower clad layer, a core portion formed on a part of the lower clad layer, and an upper clad layer formed on the lower clad layer for covering the core portion, wherein at least one selected form the lower clad layer, the core portion, and the upper clad layer is a cured product of the radiation-sensitive composition according to claim 1.
